(19) United States
(12) Patent Application Publication
(10) Pub. No.: US 2005/0084648 A1
(43) Pub. Date: Apr. 21, 2005

(54) Process for forming a part having an integral feature, a part produced thereby and apparatus therefor

(76) Inventors: Robert F. Olsen, Monroe, MI (US); Joseph R. Debortoli, Oak Harbor, OH (US); Scott M. Medley, Monroe, MI (US); Douglas A. Guntsch, Toledo, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/687,041

(22) Filed: Oct. 16, 2003

(51) Int. Cl. B32B 3/06

(52) U.S. Cl. 428/100; 264/534; 425/535

(57) ABSTRACT

A process and apparatus for forming a part having an integral feature in which a heated parison is positioned in a mold having opposed movable mold sections, each having a face. At least one of the mold sections includes an opening spaced from the face. The mold further includes a movable pressing member positioned adjacent to the opening. A portion of the parison extends through the opening during formation. The pressing member is moved to compress the parison portion to form an integral feature on the part.

### BACKGROUND OF THE INVENTION

The present invention is generally relates to plastic blow molding. More specifically, the invention is directed to a plastic blow molding process for forming a part having an integral feature, a part produced thereby and apparatus therefor.

In the past, plastic blow molded parts have been formed using processes and apparatus in which features such as flanges have been formed along a parting line where mold sections come together when closed. It has been found that these prior processes and apparatus limit the positioning of the features on the part at the parting line. This has resulted in separate features such as metal brackets being added to the part after molding in order to provide a necessary feature for the part.

There is a need for a process and apparatus to produce a plastic blow molded part that has an integral feature that can be formed at points spaced from the parting line depending on the use of the part. The present invention satisfies this need.

### SUMMARY OF THE INVENTION

The present invention is directed to a process and apparatus for forming a part having an integral feature. The process and apparatus includes a mold having two opposed mold sections for receiving a heated parison. Each mold section has a face. The mold sections are closeable upon one another at said faces at a parting line. Each of the mold sections has a sidewall including a female cavity having a predetermined shape of a part to be formed in the mold. At least one of the mold sections has an opening in the female cavity extending through the sidewall. The opening is positioned in spaced relationship with said face. The mold includes one or more movable pressing members positioned adjacent to the opening. Each pressing member has a predetermined shape of a feature to be formed by the pressing member. A part having an integral member is formed in the mold by blowing a pressurized gas into the parison to expand the parison against the female cavities and to cause a portion of the parison to extend through the opening. The pressing member compresses the portion of the parison to form an integral feature on the part.

It is a primary object of the present invention to provide a process and an apparatus for forming a part having an integral feature.

Other objects and advantages of the present invention shall become apparent to those skilled in the art upon a review of the following detailed description of the preferred embodiments and the accompanying drawings.

### BRIEF DESCRIPTION OF THE DRAWINGS

FIG. 1 is a perspective view of a first embodiment part having an integral feature according to the present invention;

FIG. 2 is a cross-sectional view of a parison positioned between a mold according to the present invention;

FIG. 3 is a cross-sectional view taken along line 3-3 of FIG. 2;

FIG. 4 is a cross-sectional view showing a mold according to the present invention in a closed position with a blowing device inserted in the parison;

FIG. 5 is a view similar to FIG. 4 in which a pressurized gas is being blown into the parison according to the present invention;

FIG. 6 is a view similar to FIG. 5 in which the pressing members according to the present invention have been moved to form the feature according to the present invention;

FIG. 7 is a detailed view of an integral feature according to the present invention in which flash is shown in phantom;

FIG. 8 is a top cross-sectional view of apparatus according to the present invention;

FIG. 9 is a side elevational cross-sectional view of apparatus according to the present invention;

FIG. 10 is a perspective view of a second embodiment part having an integral feature according to the present invention;

FIG. 11 is a cross-sectional view of a parison positioned between a second embodiment mold according to the present invention;

FIG. 12 is a cross-sectional view showing the second embodiment mold in a closed position during which a pressurized gas is being blown into the parison;

FIG. 13 is a cross-sectional view of the second embodiment mold in which the pressing members have been moved to form the integral feature according to the present invention;

FIG. 14 is a cross-sectional view taken along line 12-12 of FIG. 13 showing a third pressing member further forming the integral feature; and

FIG. 15 is a view similar to FIG. 14 in which the third pressing member has completed the formation of the integral feature.

### DETAILED DESCRIPTION OF THE PREFERRED EMBODIMENTS

The preferred embodiments and best mode of the present invention will now be described in detail with reference being made to the drawings which form a part of the disclosure of the invention. In the drawings, a part having an integral feature according to the present invention is indicated generally by the reference number “10”.

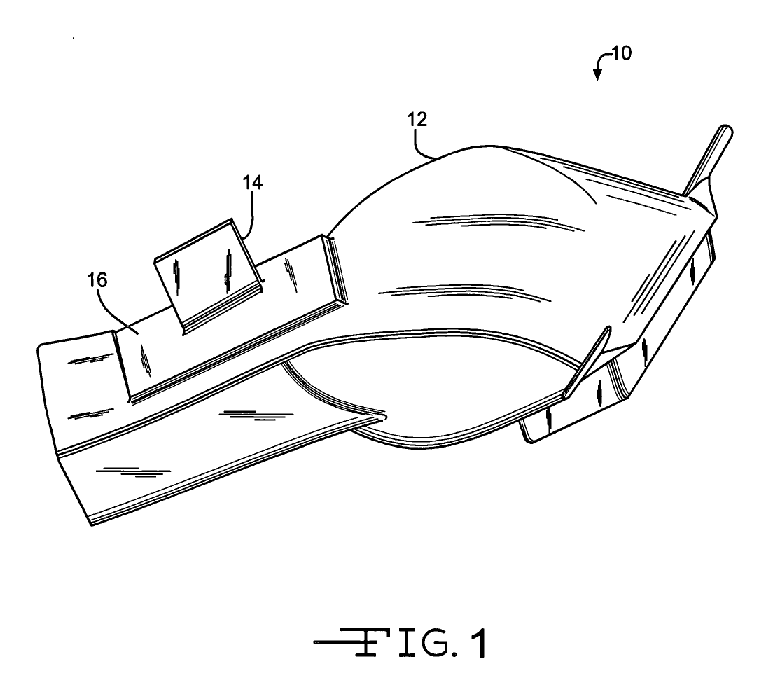

Referring to FIG. 1, the part 10 is an automotive heating, ventilation, air conditioning (HVAC) duct. The part 10 includes a body 12 having an integral feature 14 formed thereon. In a preferred embodiment, the feature 14 is a flange such as a mounting tab. The feature 14 can be used to mount the part 10 on a vehicle. As shown, a raised reinforcement surface 16 is formed on the body 12 adjacent to the feature 14. The surface 16 strengthens the feature 14. In another embodiment, the part 10 can be formed without the surface 16.

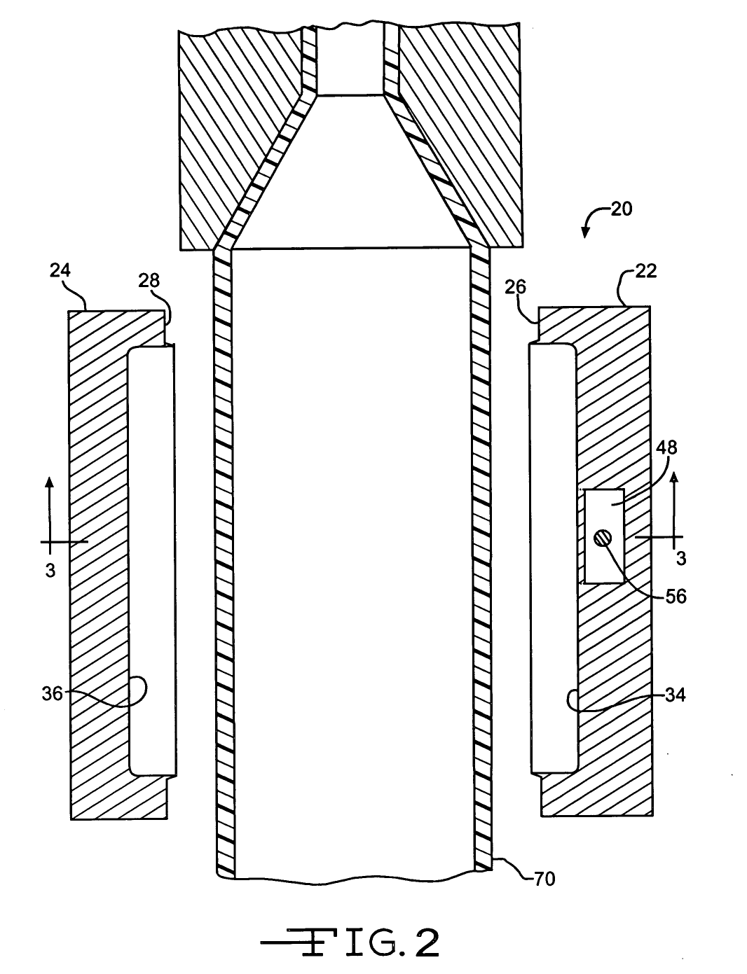

Referring to FIGS. 2-9, the part 10, as shown in FIG. 1, is formed by a process and apparatus that includes a mold 20. The mold 20 has two opposed mold sections 22 and 24 having faces 26 and 28, respectively. The mold sections 22 and 24 are constructed of a suitable metallic material. Examples of such materials include the group as follows: aluminum alloys, beryllium-copper alloys, steel and zinc alloys.

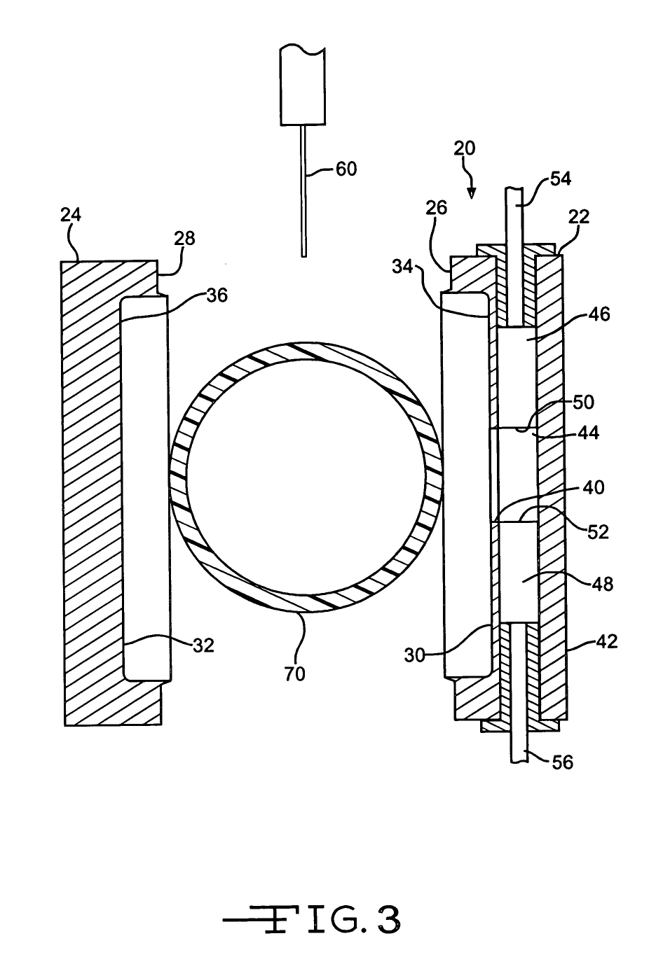

As shown in FIG. 3, the mold sections 22 and 24 include sidewalls 30 and 32, respectively. The sidewalls 30 and 32 include female cavities 34 and 36, respectively, that have a predetermined shape of a part, such as part 10, to be formed in the mold 20.

Still referring to FIG. 3, the mold section 22 has an opening 40 in the cavity 34 that extends through the sidewall 30. The opening 40 is positioned in spaced relationship with the face 26. In this regard, the opening 40 is spaced toward the center of the cavity 34 so that a portion of the sidewall 30 is positioned between the face 26 and the opening 40. However, it should be understood that the opening 40 can be placed in a variety of positions along the sidewall 30 so long as there is a portion of the sidewall 30 between the face 26 and the opening 40.

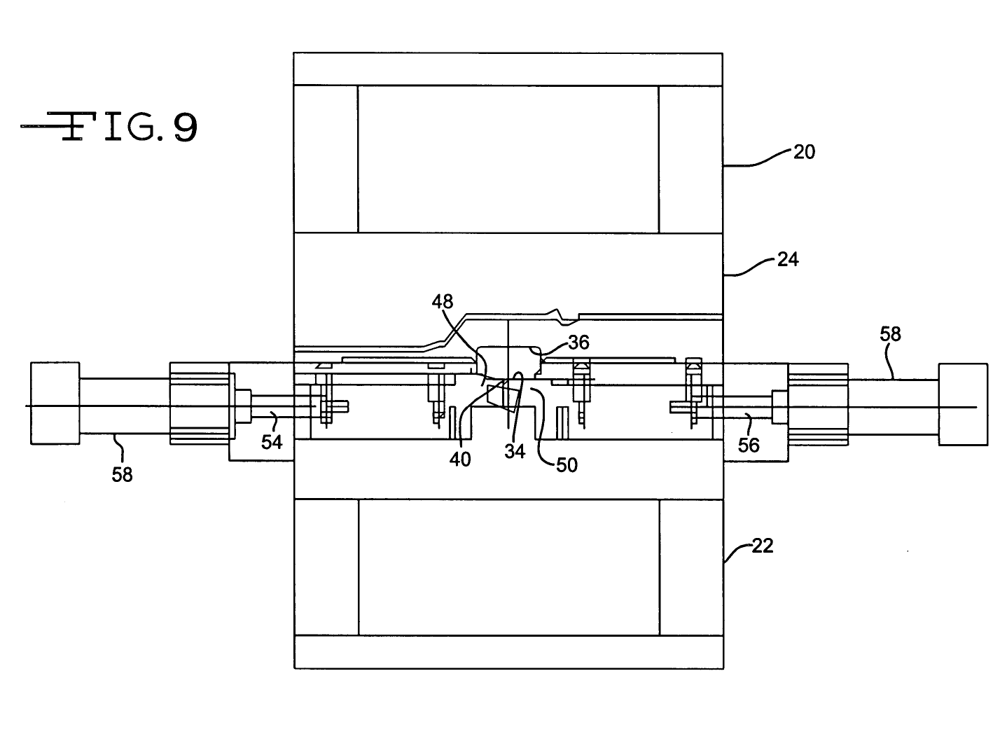

Referring to FIGS. 3, 8 and 9, the mold section 22 includes an exterior wall 42 spaced horizontally from the sidewall 30 to form a space 44. The mold 20 includes one or more movable pressing members positioned in the space 44 adjacent to the opening 40. In a preferred embodiment, the mold 20 includes two opposed aligned reciprocally movable pressing members 46 and 48 positioned in the space 44 adjacent to the opening 40. The pressing members 46 and 48 include pressing surfaces 50 and 52, respectively, that have a predetermined shape of a the feature, such as feature 14 shown in FIG. 1, to be formed by the pressing members 46 and 48. The pressing members 46 and 48 have push rods 54 and 56, respectively, that are operatively connected to hydraulic apparatus 58 (FIGS. 8 and 9) for reciprocally moving the pressing members 46 and 48. As shown in FIG. 3, the mold 20 includes a blowing device 60 such as a blow pin. The blowing device 60 blows a pressurized gas such as air.

Referring to FIGS. 2-9, a heated parison 70 is positioned in the mold 20 between the mold sections 22 and 24. The parison 70 is constructed of a suitable thermoplastic material. Examples of such materials include the group as follows: acrylonitrile-butadiene-styrene (ABS), high-density polyethylene (HDPE), low-density polyethylene (LDPE), linear low-density polyethylene (LLDPE), polycarbonate (PC), polyethylene terephthalate (PET), polypropylene (PP), polyphenylene ether (PPE), polyvinylchloride (PVC), thermal plastic elastomer (TPE) and ultra high molecular weight polyethylene (UHMW-PE).

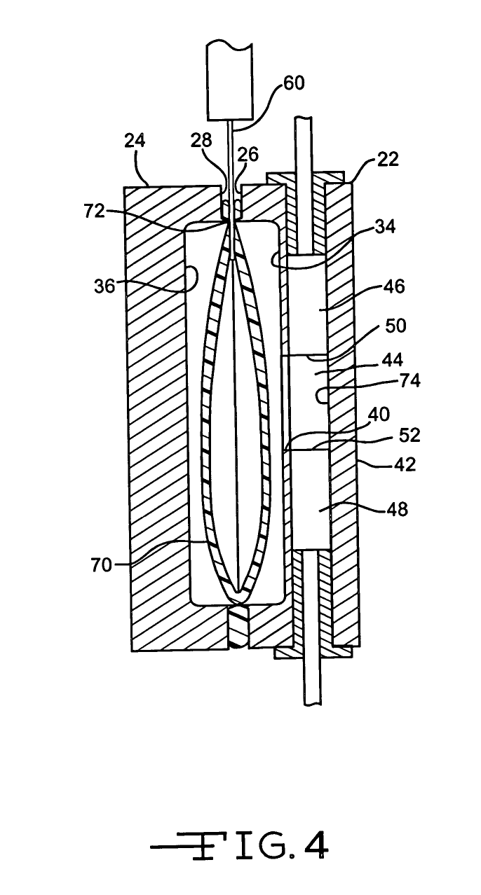

As shown in FIG. 4, the mold sections 22 and 24 are moved to a closed position in which the opposed faces 26 and 28 meet at a parting line 72. When in this position, the parison 70 is positioned within the mold sections 22 and 24 adjacent to the respective cavities 34 and 36. The blowing device 60 is positioned in the parison 70. As shown in FIG. 4, portions of the parison are positioned outside of the cavities 34 and 36 along the parting line 72. The pressing members 46 and 48 are in a retracted position. When in this position, the pressing surfaces 50 and 52 form a cavity 74 with the exterior wall 42 adjacent to the opening 40. As shown in FIG. 4, the opening 40 is spaced from the parting line 72 so that a portion of the sidewall 30 is between the opening 40 and the parting line 72.

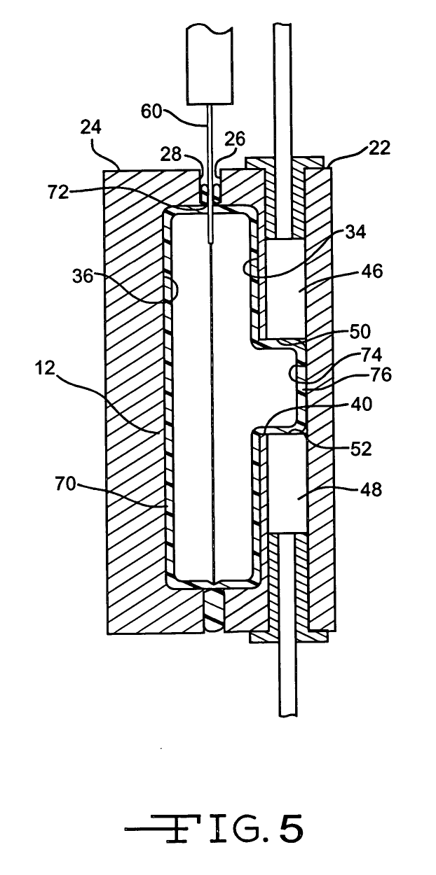

Referring to FIG. 5, the blowing device 60 blows a pressurized gas into the parison 70 to expand the parison against the cavities 34 and 36 to form the body 12 of the part 10 (FIG. 1). The blowing of the pressurized gas also causes a portion 76 of the parison 70 to extend through the opening 40 into the cavity 74.

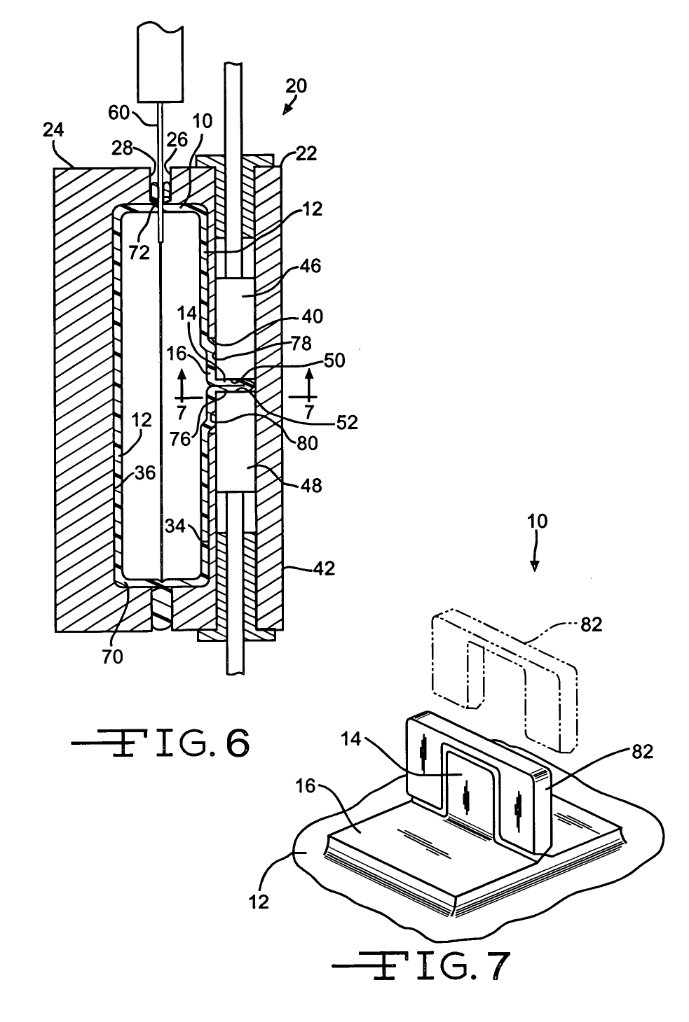

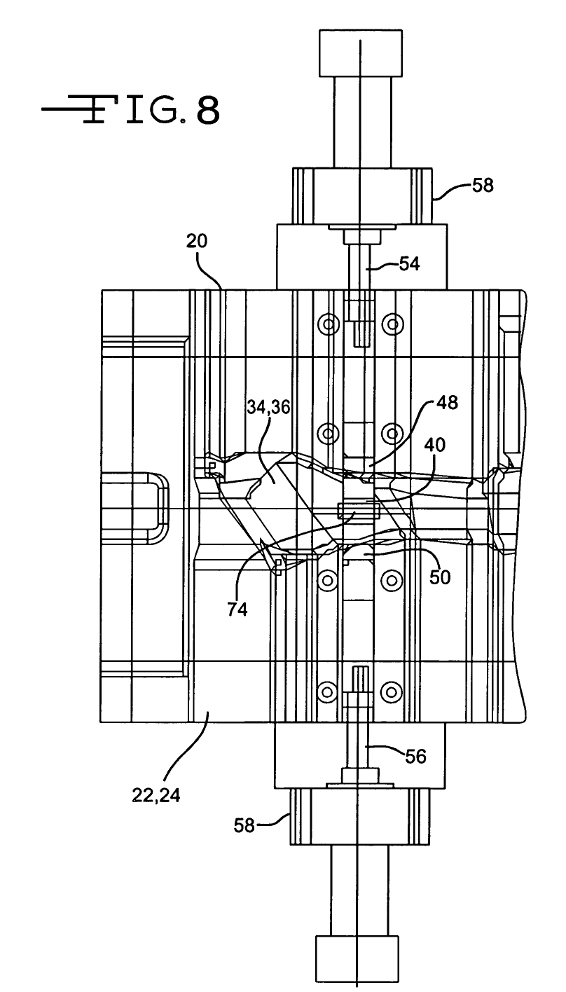

As shown in FIG. 6, the pressing members 46 and 48 are actuated so that the pressing surfaces 50 and 52, respectively, move toward one another. The pressing surfaces 50 and 52 compress the portion 76 of the parison 70 to form an integral feature 14 (FIG. 1). Still referring to FIG. 6, the support surface 16 of the part 10 (FIG. 1) is formed adjacent to the opening 40 by the sides 78 and 80 of the pressing members 46 and 48, respectively. The feature 14 and the support surface 16 of the part 10 are formed at a position spaced away from the face 26 of the mold section 22 and the parting line 72. After formation of the part 10, the pressing members 46 and 48 are retracted, the blowing device 60 is removed and the mold sections 22 and 24 are moved apart from one another to allow for the part 10 to be removed from the mold 20. As shown in FIG. 7, the flash 82 around the feature 14 is removed along with any other flash of the parison 70. It has been found that the formation of the feature 14 with the flash 82 provides the feature 14 with added strength and durability.

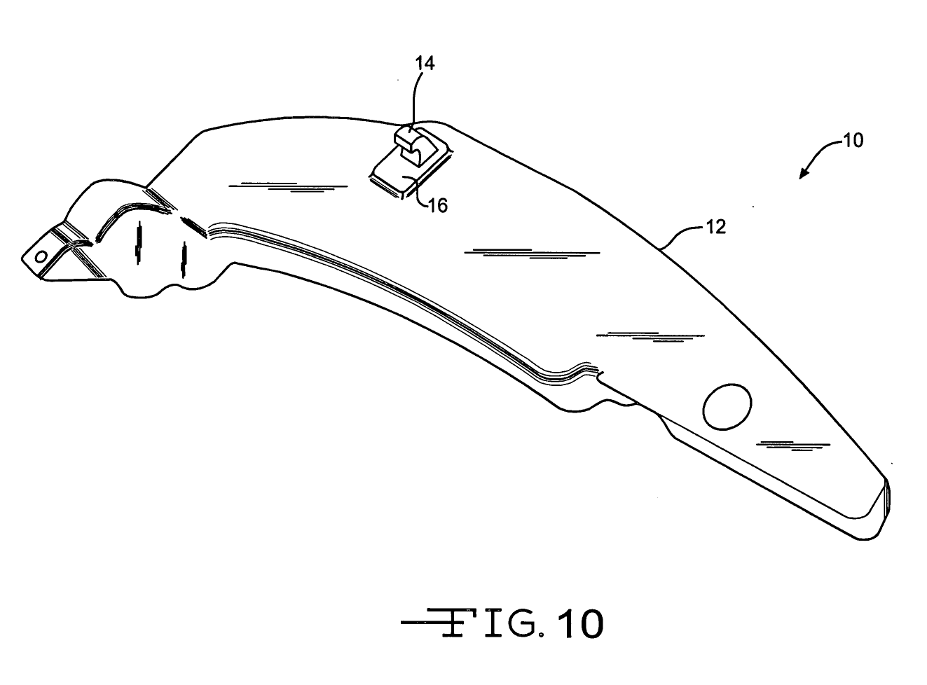

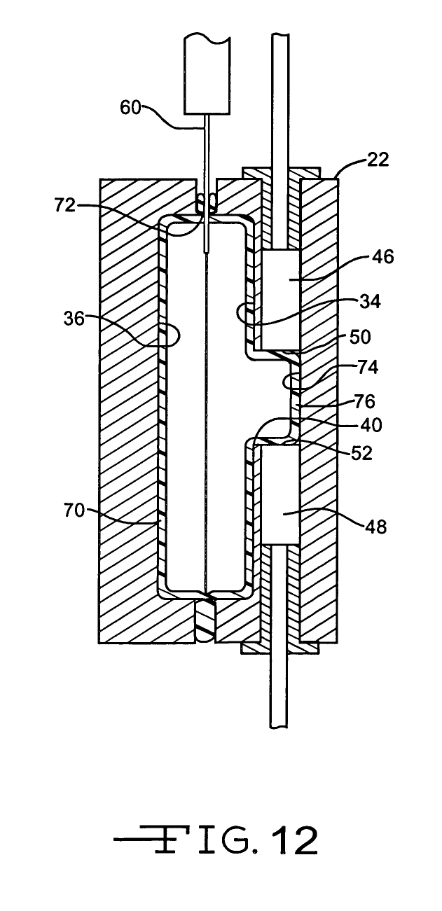

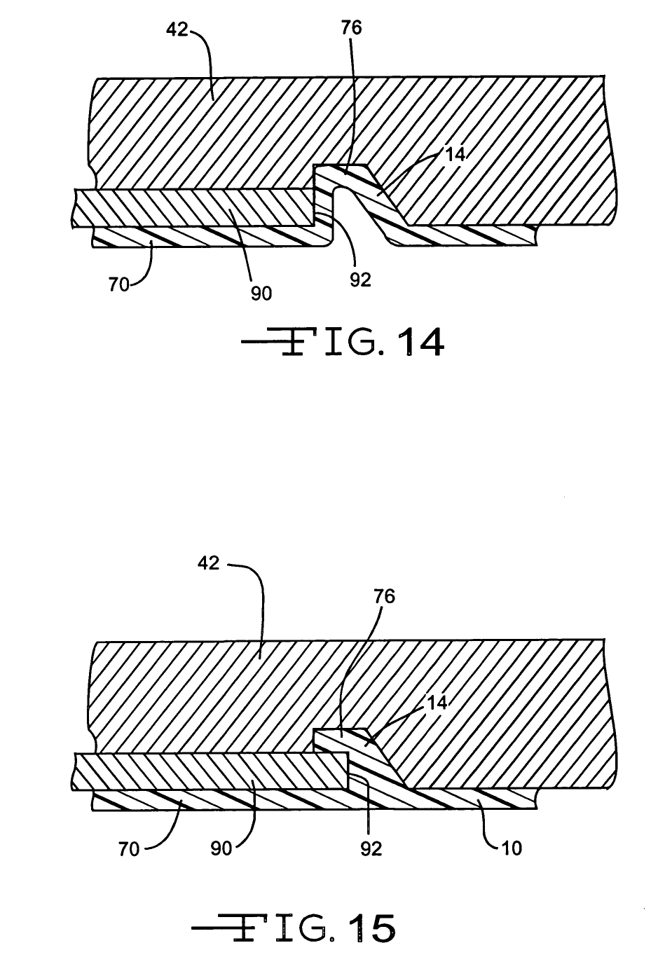

Referring to FIGS. 10-15, a second embodiment part 10 such as an automotive fluid reservoir is shown. The part 10 includes a body 12 having a feature 14 such as a hook. As shown, the feature 14 is positioned on the body 12 on a raised support surface 16. In another embodiment, the part 10 can be formed without the surface 16.

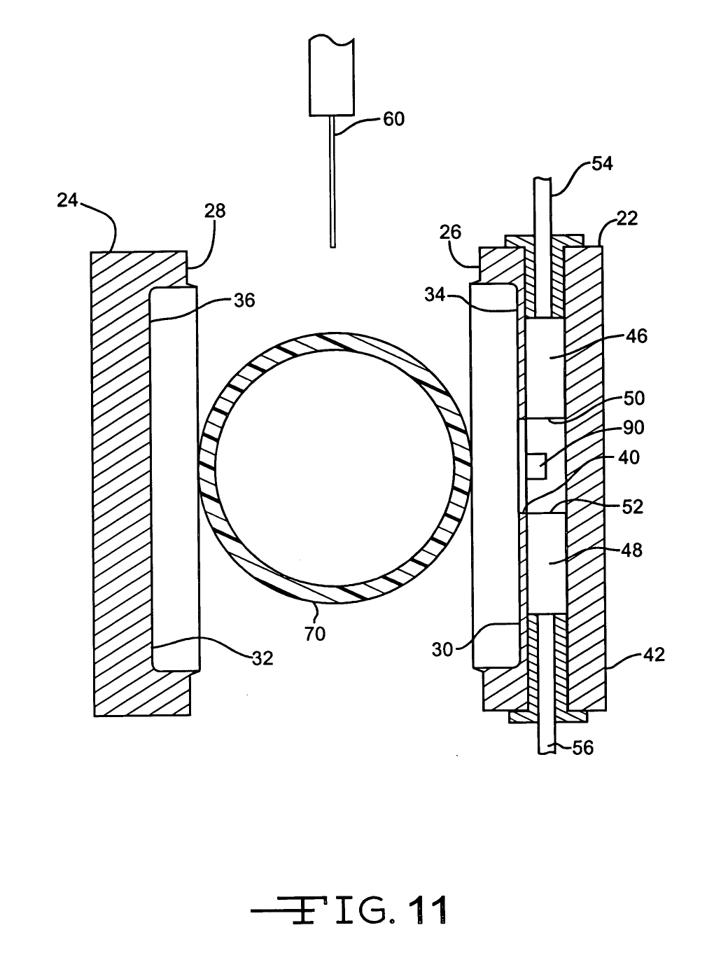

As shown in FIGS. 11-15, the second embodiment part 10 is formed by the process and apparatus as described above. Accordingly, the same reference numbers have been used.

In the second embodiment, the process and apparatus includes a third pressing member 90 that is positioned substantially perpendicular to the pressing members 46 and 48. The third pressing member 90 is shown in FIGS. 11, 14 and 15. The third pressing member 90 is reciprocally movable by hydraulic apparatus similar to that shown in FIGS. 8 and 9.

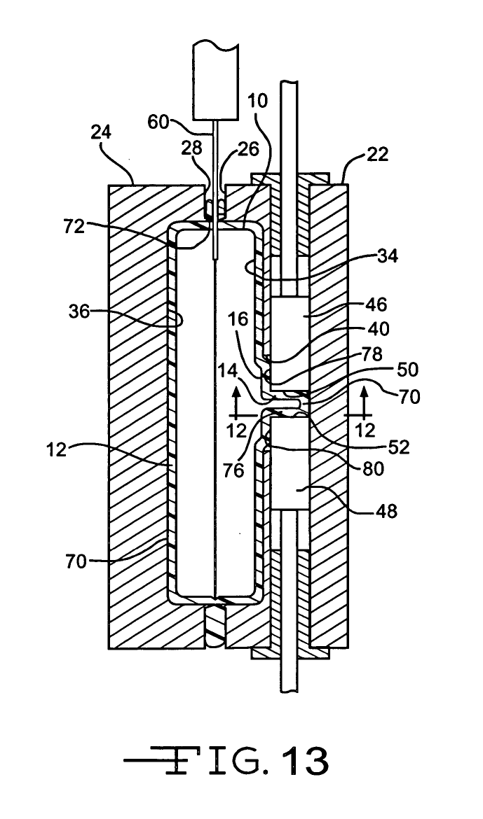

Referring to FIGS. 13-15, the process as described above reaches the point where the portion 76 of the parison 70 is being compressed by the pressing members 46 and 48 to form the feature 14. At this point, the third pressing member 90, which has a pressing surface 92 including a predetermined shape, compresses the portion 76 as shown in FIG. 15 to form the feature 14 with a hook as shown in FIG. 10. After formation of the part 10, the pressing members 50, 52 and 90 are retracted, the blowing device 60 is removed and the mold sections 22 and 24 are moved apart from one another to allow the part 10 to be removed from the mold 20. Any flash is removed to finish the part 10.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1. A process for forming a part having an integral feature comprising:
positioning a heated parison in a mold having opposed movable mold sections each having a face, said mold sections being closeable upon one another at said faces at a parting line, each of said mold sections having a sidewall including a female cavity having a predetermined shape of a part to be formed in said mold, at least one of said mold sections having an opening in said female cavity extending through said sidewall, said opening being positioned in spaced relationship with said face, said mold including a movable pressing member positioned adjacent to said opening, said pressing member having a predetermined shape of a feature to be formed by said pressing member;
closing said mold sections around said parison along said parting line;
blowing a pressurized gas into said parison to expand said parison against said female cavities of said mold sections to form said part and to cause a portion of said parison to extend through said opening; and
moving said pressing member to compress said portion of said parison to form an integral feature on said part.

2. A part formed in accordance with the process of claim 1.

3. The process of claim 1, wherein said parison is formed of a thermoplastic material.

4. The process of claim 3, wherein said thermoplastic material is selected from the group consisting of acrylonitrile-butadiene-styrene (ABS), high-density polyethylene (HDPE), low-density polyethylene (LDPE), linear low-density polyethylene (LLDPE), polycarbonate (PC), polyethylene terephthalate (PET), polypropylene (PP), polyphenylene ether (PPE), polyvinylchloride (PVC), thermal plastic elastomer (TPE) and ultra high molecular weight polyethylene (UHMW-PE).

5. The process of claim 1, wherein said pressing member includes two opposed pressing members.

6. A part formed in accordance with the process of claim 5.

7. The process of claim 1, wherein said pressing member includes two opposed pressing members and a third pressing member being positioned substantially perpendicular to said two opposed pressing members.

8. A part formed in accordance with the process of claim 7.

9. The process of claim 1, wherein said predetermined shape of a feature is a flange.

10. A part formed in according with the process of claim 9.

11. The process of claim 1, wherein said predetermined shape of a feature is a hook.

12. A part formed in accordance with the process of claim 11.

13. A part comprising:
a plastic body having an integral feature formed by a process having a mold section with a face, said mold section having a sidewall including a female cavity having an opening extending through said sidewall, said opening being positioned in spaced relationship with said face, said mold including a movable pressing member positioned adjacent to said opening, said pressing member having a predetermined shape, said pressing member forming said integral feature when moved.

14. The part of claim 13, wherein said integral feature is a flange.

15. The part of claim 13, wherein said integral feature is a hook.

16. Apparatus for use in a process for forming a part having an integral feature comprising:
a mold having two opposed mold sections each having a face, said mold sections being closeable upon one another at said faces at a parting line, each of said mold sections having a sidewall including a female cavity having a predetermined shape of a part to be formed in said mold, at least one of said mold sections having an opening in said female cavity extending through said sidewall, said opening being positioned in spaced relationship with said face, said mold including a movable pressing member positioned adjacent to said opening, said pressing member having a predetermined shape of a feature to be integrally formed on said part by said pressing member.

17. The apparatus of claim 16, wherein said pressing member includes two opposed pressing members.

18. The apparatus of claim 16, wherein said pressing member includes two opposed pressing members and a third pressing member being positioned substantially perpendicular to said two opposed pressing members.

19. The apparatus of said claim 16, wherein said predetermined shape of a feature is a flange.

20. The apparatus of claim 16, wherein said predetermined shape of a feature is a hook.
